(19) United States
(12) Patent Application Publication
(10) Pub. No.: US 2011/0158035 A1
(43) Pub. Date: Jun. 30, 2011

(54) BEVERAGE STIRRER

(75) Inventors: Connie M. Hendrickson, Irving, TX (US); Andrew D. Bradford, Winston-Salem, NC (US); David S. McCabe, East Greenwich, RI (US)

(73) Assignee: Arkon Consultants

(21) Appl. No.: 12/969,831

(22) Filed: Dec. 16, 2010

Related U.S. Application Data
(60) Provisional application No. 61/291,597, filed on Dec. 31, 2009.

(51) Int. Cl. B01F 13/00; B05D 3/02; B05D 3/10

(52) U.S. Cl. 366/129; 427/385.5; 427/393; 427/389.9; 427/384

(57) ABSTRACT

A method for making a beverage stirrer is provided which comprises (a) providing a beverage stirrer having an elongated body and comprising a porous substrate; (b) treating the substrate with a composition comprising a non-silicone antifoaming agent disposed in a liquid medium such that a portion of the composition is absorbed by the porous substrate; and (c) drying the treated substrate.

### CROSS-REFERENCE TO RELATED APPLICATION

This application claims the benefit of priority from U.S. Provisional Application No. 61/291,597, filed Dec. 31, 2009, having the same title, and having the same inventors, and which is incorporated herein by reference in its entirety.

### FIELD OF THE DISCLOSURE

The present disclosure relates generally to beverage accessories, and in particular, to beverage stirrers treated with a non-silicone antifoaming agent.

### BACKGROUND OF THE DISCLOSURE

In many situations, the formation of foam encountered while decanting a carbonated beverage into a receptacle is undesirable. For example, in the airline or restaurant industries, the formation of such foams slows down the beverage preparation and serving process. Moreover, such foaming frequently causes the decanted beverage to overflow the sides of the receptacle, which requires clean-up and further hinders the preparation and serving of beverages.

Some attempts have been made in the art to overcome the aforementioned difficulties. For example, U.S. Pat. No. 5,568,973 (Gorab) describes an antifoam beverage stirrer. A portion 16 of the stirrer 14 disposed in a glass 12 is treated ANTIFOAM® 10, an antifoaming agent manufactured by the Dow Chemical Company. ANTIFOAM® 10 is a 10% active, food-grade silicone emulsion designed to control foam in aqueous systems. In use, the stirrer is deposited in a carbonated beverage receptacle while the beverage is being poured to reduce foaming.

### SUMMARY OF THE DISCLOSURE

In one aspect, a method for making a beverage stirrer is provided which comprises (a) providing a beverage stirrer having an elongated body and comprising a porous substrate; (b) treating the substrate with a composition comprising a non-silicone antifoaming agent disposed in a liquid medium such that a portion of the composition is absorbed by the porous substrate; and (c) drying the treated substrate.

In another aspect, a method is provided for making a beverage stirrer. The method comprises (a) providing a beverage stirrer having an elongated body and comprising a porous substrate; (b) treating the substrate with a composition comprising a non-silicone antifoaming agent disposed in a liquid medium such that a portion of the composition is absorbed by the porous substrate; and (c) drying the treated substrate.

In still another aspect, a beverage stirrer is provided which comprises an elongated body, and a water-insoluble antifoaming agent disposed on said elongated body.

### BRIEF DESCRIPTION OF THE DRAWINGS

FIG. 1 is an illustration of a prior art beverage stirrer.

### DETAILED DESCRIPTION

While the beverage stirrers described in U.S. Pat. No. 5,568,973 (Gorab) may work for their intended purpose, the approach represented by these stirrers is undesirable. In particular, these stirrers appear to operate by allowing some of the antifoaming agent present on the stirrer to dissolve or disperse into the beverage, thus reducing foaming by reducing the surface tension of the beverage. In practice, however, it is found that the dissolved or dispersed antifoaming agent can detract from the flavor of the beverage. Moreover, while some of the antifoaming agents described in the reference have been approved for use in foods, there is always a risk that these materials will ultimately be found to be carcinogenic or to cause or contribute to other adverse physiological side effects. There is thus a need in the art to control the formation of foams in carbonated beverages without introducing chemicals into the beverage itself.

It has now been found that the foregoing need may be met through the provision of a beverage stirrer having an antifoaming agent on the surface thereof. The antifoaming agent on the stirrer is chemically and/or physically bonded to the substrate and is essentially insoluble in water-based carbonated beverages so that it remains on the stirrer during use, thus providing an antifoaming effect without contaminating the beverage or affecting the taste thereof. Such a stirrer may be made, for example, by treating or impregnating a (preferably porous) substrate with an antifoaming agent. Notably, unlike the stirrers of U.S. Pat. No. 5,568,973 (Gorab), the stirrers described herein do not rely on reducing surface tension in achieving an antifoaming effect.

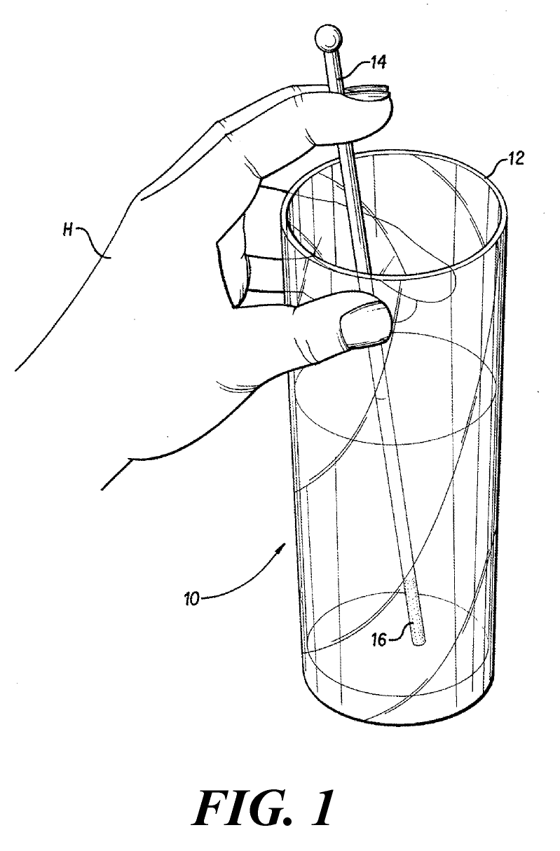

Beverage stirrers of various designs and geometrical configurations may be made in accordance with the teachings herein. Preferably, however, they will be similar in appearance to the beverage stirrer 14 depicted in FIG. 1, but will have an antifoaming agent 16 of the type described herein.

Various materials may be utilized in the construction of the beverage stirrers made in accordance with the teachings herein. Preferably, the beverage stirrers will comprise an absorbent or porous material. Stirrers of this type may be constructed, for example, out of various cellulosic materials, fibrous materials, porous metals, or porous plastics, with wooden stirrers being especially preferred. However, beverage stirrers of the type described herein may be made of various materials, the key consideration being that the antifoaming agent is capable of being applied to the beverage stirrer so that it chemically and/or physically bonds to the surface of the stirrer body and does not substantially dissolve in water and/or in the types of aqueous solutions typically consumed as beverages.

Various antifoaming agents may be utilized in the devices and methodologies disclosed herein. Suitable antifoaming agents include those which may be chemically and/or physically bonded to the stirrer substrate.

The antifoaming compositions used in the devices and methodologies described herein may be applied to the stirrer as oil-in-water dispersions or emulsions in which the oil phase contains at least one hydrophobic compound, and the aqueous phase contains at least one stabilizer and possibly a thickener. In some embodiments, the antifoaming composition may be applied as oil-in-water emulsions which contain aliphatic alcohols having relatively high melting points, and hydrocarbons which are liquid at room temperature. The oil phase of the oil-in-water emulsions may, if required, also contain further components acting as antifoaming agents, such as non-aromatic hydrocarbons, fatty acids or derivatives thereof having relatively high melting points. Examples of the later include fatty acid esters, beeswax, Carnauba wax, Japan wax and montan wax.

In other embodiments, the antifoaming composition may be applied as an oil-in-water emulsion whose oil phase contains an alcohol of at least 12 carbon atoms, fatty acid esters of alcohols of at least 22 carbon atoms and C₁- to C₃₆-carboxylic acids, or fatty acid esters of C₁₂- to C₂₂-carboxylic acids with monohydric to trihydric C₁- to C₁₈-alcohols. The oil phase may also contain a hydrocarbon having a boiling point above 200° C., or fatty acids of 12 to 22 carbon atoms in combination with polyglyceryl esters which are obtainable by at least 20% esterification of polyglycerol mixtures with at least one fatty acid of 12 to 36 carbon atoms. These oil-in-water emulsions may be stabilized with the aid of a water-soluble emulsifier.

In other embodiments, the antifoaming composition may be applied as oil-in-water emulsions which contain, in the oil phase, (a) fatty acid esters of C₁₂- to C₂₂-carboxylic acids with monohydric to trihydric C₁- to C₂₂-alcohols, (b) polyglyceryl esters which are obtainable by at least 20% esterification of polyglycerols which have at least 2 glycerol units with at least one C₁₂- to C₃₆-fatty acid and (c) fatty acid esters of C₁₂- to C₂₂-carboxylic acids and polyalkylene glycols, the molar mass of the polyalkylene glycols being up to 5000 g/mol. The hydrophobic phase may, if required, contain further components, such as alcohols of at least 12 carbon atoms or hydrocarbons having a boiling point above 200° C. These oil-in-water emulsions may be stabilized with the aid of an emulsifier.

In other embodiments, the antifoaming composition may be applied as oil-in-water emulsions in which the oil phase contains (a) at least one alcohol of at least 12 carbon atoms, distillation residues which are obtainable in the preparation of alcohols having a relatively high number of carbon atoms by oxo synthesis or by the Ziegler process, or mixtures of said compounds, and (b) at least one ester of a sugar alcohol having at least 4 OH groups or at least 2 OH groups and at least one intramolecular ether bond and a fatty acid of at least 20 carbon atoms in a molar ratio of 1 to at least 1, it being possible for some or all of the free OH groups of these esters to be esterified with C₁₂- to C₁₈-carboxylic acids.

In still other embodiments, the antifoaming composition may be applied as oil-in-water emulsions which contain a hydrophobic phase comprising fatty acid esters of alcohols of at least 22 carbon atoms and C₁- to C₃₆-carboxylic acids, polyethylene waxes, natural waxes, hydrocarbons having a boiling point above 200° C. or fatty acids of 12 to 22 carbon atoms.

In further embodiments, the antifoaming composition may contain from 10 to 90% by weight of a surface-active polyether, such as polyalkoxylated glycerol or polyalkoxylated sorbitol, and from 10 to 90% by weight of a fatty acid ester of polyhydric alcohols, such as mono- or diesters of fatty acids and polyethylene glycol and/or polypropylene glycol, the antifoams being free of any oils, amides, hydrophobic silica or silicones. The antifoaming composition may also be applied as oil-in-water emulsions which contain, in the hydrophobic oil phase, 3-thiaalkan-1-ols, 3-thiaoxoalkan-1-ols, 3-thiadioxoalkan-1-ols, esters of said compounds or mixtures thereof.

Another class of antifoaming agents which may be suitable for use in some of the devices and methodologies described herein comprise ethylenebisstearamide or other aliphatic diamides together with at least one compound from the group consisting of the mono- and diesters of polyethylene glycol and fatty acids, sulfonated mineral oils and ethoxylation products of alcohols of 10 to 14 carbon atoms.

In still other embodiments, the antifoaming composition may be applied as oil-in-water emulsions which contain at least one compound from the group consisting of the alcohols of at least 12 carbon atoms, alkoxylated fatty alcohols, mono-, di- and triglycerides of fatty acids, fatty acid esters of carboxylic acids of at least 12 carbon atoms and monohydric to tetrahydric alcohols of 1 to 24 carbon atoms, hydrocarbons having a boiling point above 200° C., fatty acids of 12 to 26 carbon atoms, 3-thiaalkan-1-ols, 3-thiaoxoalkan-1-ols, 3-thiadioxoalkan-1-ols and esters of thiaalkane compounds and whose aqueous phase contains at least one stabilizer and, if required, a thickener, if the oil-in-water dispersions contain (i) at least one polyglyceryl ester which is obtainable by at least 20% esterification of polyglycerol with a carboxylic acid of 12 to 36 carbon atoms and (ii) at least one bisamide of ethylenediamine and carboxylic acids of 10 to 36 carbon atoms.

In still other embodiments, the antifoaming composition may be applied as oil-in-water emulsions which contain mixtures of (i) at least one polyglyceryl ester which is obtainable by at least 20% esterification of polyglycerol with a carboxylic acid of 12 to 36 carbon atoms and (ii) at least one bisamide of ethylenediamine and carboxylic acids of 10 to 36 carbon atoms as an additive for antifoams and/or deaerators based on oil-in-water dispersions.

Suitable compounds which may be used to form the hydrophobic phase of the oil-in-water dispersions used in making the beverage stirrers described herein include, for example, C₁₂- to C₄₈-alcohols, such as myristyl alcohol, cetyl alcohol, stearyl alcohol, palmityl alcohol, tallow fatty alcohol and behenyl alcohol, and synthetic alcohols, for example saturated, straight-chain, unbranched alcohols obtainable by the Ziegler process by oxidation of alkylaluminums. Synthetic alcohols may also be used for this purpose which are obtained by oxo synthesis. These alcohols may contain, for example, up to 48 carbon atoms in the molecule. For example, the antifoaming agent may contain mixtures of at least one C₁₂- to C₂₆-alcohol and at least one fatty alcohol having 28 to 48 carbon atoms in the molecule.

In some embodiments, the antifoaming agent may comprise distillation residues which are obtainable in the preparation of alcohols having a relatively large number of carbon atoms by oxo synthesis or by the Ziegler process. Other suitable antifoaming agents include alkoxylated alcohols and alkoxylated distillation residues which are obtained in the preparation of alcohols by oxo synthesis or by the Ziegler process. The alkoxylated compounds may be obtained by reacting the long-chain alcohols or distillation residues with ethylene oxide or with propylene oxide or with a mixture of ethylene oxide and propylene oxide. In this case, first ethylene oxide and then propylene oxide can be subjected to an addition reaction with the alcohols or the distillation residues or the addition reaction may be carried out first with propylene oxide and then with ethylene oxide. In general, up to 5 mol of ethylene oxide or propylene oxide undergo the addition reaction per OH group of the alcohol. Particularly preferred from the group consisting of the alkoxylated compounds are those reaction products which are prepared by an addition reaction of 1 or 2 mol of ethylene oxide with 1 mol of fatty alcohol or distillation residue.

The aforementioned fatty alcohols having at least 12 carbon atoms in the molecule may be used in combination with other compounds having antifoaming properties. Such compounds may include fatty acid esters of C₁₂- to C₂₆-carboxylic acids of, for example, C₁₂-C₂₂-carboxylic acids, with monohydric to tetrahydric C₁-C₂₄-alcohols, preferably C₁-C₂₂-alcohols, and more preferably C₃-C₁₈-alcohols. The fatty acids on which these esters are based are, for example, lauric acid, myristic acid, palmitic acid, stearic acid, arachidic acid, behenic acid, lignoceric acid and cerotic acid. Palmitic acid, stearic acid or behenic acid is preferably used. Monohydric, dihydric, trihydric, tetrahydric, or polyhydric C₁- to C₂₄-alcohols can be used for esterifying the carboxylic acids. Suitable monohydric alcohols include, for example, methanol, ethanol, propanol, butanol, hexanol, dodecanol, stearyl alcohol and behenyl alcohol. Suitable dihydric alcohols include, for example, ethylene glycol. Suitable trihydric alcohols include, for example, glycerol. Suitable tetrahydric alcohols include, for example, pentaerythritol. The polyhydric alcohols may be completely or only partially esterified.

Another class of antifoaming agents which may be suitable in some of the devices and methodologies described herein are polyglyceryl esters. Such esters may be prepared, for example, by esterifying polyglycerols which contain at least 2 glycerol units with at least one C₁₂- to C₃₆-carboxylic acid. The polyglycerols may be obtained, for example, by alkali-catalyzed condensation of glycerol at relatively high temperatures or by reaction of epichlorohydrin with glycerol in the presence of acidic catalysts. The polyglycerols usually contain from at least 2 to about 30, preferably from 2 to 12, glycerol units. Commercial polyglycerols contain mixtures of polymeric glycerols, for example mixtures of diglycerol, triglycerol, tetraglycerol, pentaglycerol and hexaglycerol and, if required, polyglycerols having a higher degree of condensation. The degree of esterification of the OH groups of the polyglycerols is from at least 20% to 100%, and preferably from 60% to 100%. The long-chain fatty acids used for the esterification may be saturated or ethylenically unsaturated. Suitable fatty acids may include, for example, lauric acid, myristic acid, palmitic acid, stearic acid, arachidic acid, behenic acid, oleic acid, hexadecenoic acids, elaidic acid, eicosenoic acids, docosenoic acids, such as erucic acid, or polyunsaturated acids, such as octadecenedienoic acids and octadecenetrienoic acids (e.g. linoleic acid and linolenic acid), and mixtures of such carboxylic acids.

Other antifoaming agents which may be used in the devices and methodologies described herein, and which may be used either alone or together with at least one alcohol of at least 12 carbon atoms, are esters of a sugar alcohol having at least 4 OH groups or at least 2 OH groups and at least one intramolecular ether bond, and a fatty acid having at least 20 carbon atoms in the molecule in a molar-ratio of 1 to at least 1, it being possible for some or all of the free OH groups of these esters to be esterified with C₁₂- to C₁₈-carboxylic acids. Esters of tetritols, pentitols and/or hexitols with fatty acids of at least 22 carbon atoms in a molar ratio of 1 to at least 1.9 may be used. Esters of mannitol and/or sorbitol with behenic acid in a molar ratio of 1 to at least 1, preferably 1 to at least 1.9, may also be used. In addition to the sugar alcohols, sorbitol and mannitol, other sugar alcohols which may be used include adonitol, arabitol, xylitol, dulcitol, pentaerythritol, sorbitan and erythritol. Sugar alcohols are understood as meaning the polyhydroxy compounds which are formed from monosaccharides by reduction of the carbonyl function, and which are not themselves sugars. The anhydro compounds which form from sugar alcohols as a result of intramolecular elimination of water may also be used. These include, for example, antifoaming agents obtained when sugar alcohols are esterified with C₂₂- to C₃₀-fatty acids. If the sugar alcohols are only partly esterified with a fatty acid of at least 20 carbon atoms, the unesterified OH groups of the sugar alcohol can be esterified with another carboxylic acid, for example a C₁₂- to C₁₈-carboxylic acid.

The hydrophobic phase of the antifoaming agents utilized in the devices and methodologies disclosed herein may furthermore contain from 1 to 100% by weight of a 3-thiaalkan-1-ol, 3-thiaoxoalkan-1-ol or 3-thiadioxoalkan-1-ol, or an ester of said compounds or of mixtures thereof.

Further compounds suitable as antifoaming agents in the devices and methodologies disclosed herein are ketones having melting points above 45° C. These may be used together with fatty alcohols whose melting points are above 40° C. The reaction products of, for example, mono- and/or diglycerides with dicarboxylic acids and reaction products of glycerol with dicarboxylic acids, which reaction products are esterified with at least one C12- to C36-fatty acid, may also be used as additives for the hydrophobic phase of the antifoaming agents described herein.

Other compounds which may enhance the efficiency of long-chain alcohols as antifoaming agents and which may be used in the devices and methodologies described herein include, for example, polyethylene waxes having a molar mass of at least 2000 and natural waxes, such as beeswax or Carnauba wax.

Further possible components of the antifoaming agents utilized herein comprise hydrocarbons having a boiling point above 200° C. (determined at atmospheric pressure). These include liquid paraffins and paraffin mixtures such as those referred to as white oil. Paraffins whose melting point is, for example, above 50° C. may also be used.

In some embodiments, the antifoaming agents used in the devices and methodologies described herein contain, in the hydrophobic phase, combinations of (i) at least one polyglyceryl ester which is obtainable by at least 20% esterification of polyglycerol with a carboxylic acid of 12 to 36 carbon atoms and (ii) at least one bisamide of ethylenediamine and carboxylic acids of 10 to 36 carbon atoms.

The amount of the polyglyceryl esters in the hydrophobic phase of the oil-in-water dispersions may be, for example, from 0.5% to 80%, or from 2% to 20%, by weight. The weight ratio of (i) polyglyceryl esters to (ii) bisamides may be, for example, from 10:1 to 1:10, or from 3:1 to 1.5:1.

Various means may be employed to chemically and/or physically bond the antifoaming agent to the substrate. In some embodiments, for example, a porous substrate is utilized for the stirrer, and the stirrer is impregnated with the antifoaming agent. In some implementations of this embodiment, the antifoaming agent may be maintained on the substrate through hydrogen bonding, ionic bonding, covalent bonding, steric hindrance, or the like. In other implementations, the applied antifoaming agent (or precursor thereof) may be polymerized, crosslinked, exposed to a radiation source (which may be, for example, a source of UV radiation or an electron beam generator), cured, dried, made to undergo a chemical reaction (this may be, for example, with itself, with the substrate, or with a chemical agent the antifoaming agent is exposed to), or otherwise treated to render it insoluble in most common beverages. Of course, it will also be appreciated that a precursor of an antifoaming agent may be applied to the substrate, and may be subsequently treated or reacted using any of the aforementioned means to create an antifoaming agent in situ.

In some embodiments, an antifoaming agent may be applied to a stirrer substrate in a suitable solvent or carrier. By way of example and not of limitation, oil based defoaming agents may be applied with an oil carrier, such as mineral oil, vegetable oil, or white oil.

In some embodiments, the antifoaming agent may contain one or more performance boosters. For example, an oil-based antifoaming agent may contain a wax and/or hydrophobic silica to boost the performance. Waxes that may be used for this purpose include, for example, ethylene bis stearamide (EBS), paraffinic waxes, ester waxes and fatty alcohol waxes.

### Example 1

The surface tension of an aqueous solution was tested with and without stirring the solution with a beverage stirrer of the type described herein. The antifoaming agent used in this example was a blend of a glycerol trioleate, glycol/glycerine, and an ethoxylated alcohol surfactant. A modified yarn draize test was used for this purpose, in which a loop of yarn is floated on the aqueous solution in each case. The time required for the yarn to drop is measured. Controls included soda (A) and a 0.1% solution of a known surface tension reducer (B) (dioctyl sulfosuccinate sodium salt). Test solutions included one prepared by leaving the stirrer overnight in the soda (C), and one prepared by pouring control or test solution over a prepared stirrer (D), directly into the container, as would be done for actual use. An additional control was prepared by pouring soda over an untreated stirrer (E). Compared to soda alone (A), no difference in drop times was observed with the solution stirred by the treated stirrer (D) or with the untreated stirrer (E). Drop times for other samples (B and C) were less than those of the previously listed samples.

Various modifications may be made to the devices and methodologies disclosed herein. For example, while the foregoing discussion has focused primarily on beverage stirrers, it will be appreciated that the principles described herein may be applied to other devices as well. For example, beverage containers may be made in accordance with the teachings herein which have an interior surface, at least a portion of which is treated with the antifoaming agents described herein.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for making a beverage stirrer, comprising:
providing a beverage stirrer having an elongated body; and
treating the stirrer with an antifoaming agent, wherein the antifoaming agent on the treated stirrer is insoluble in water.

2. The method of claim 1, wherein treating the stirrer with the antifoaming agent causes the antifoaming agent to become chemically bonded to the surface of the stirrer.

3. The method of claim 1, wherein treating the stirrer with the antifoaming agent causes the antifoaming agent to become crosslinked.

4. The method of claim 1, wherein treating the stirrer with the antifoaming agent causes the antifoaming agent to undergo polymerization.

5. The method of claim 1, wherein the stirrer is porous.

6. The method of claim 1, wherein at least a portion of the outer surface of the stirrer comprises a cellulosic material.

7. The method of claim 1, wherein the stirrer is wooden.

8. The method of claim 1, wherein the stirrer comprises a fibrous material.

9. The method of claim 1, wherein treating the stirrer comprises exposing the stirrer to a composition comprising an antifoaming agent or antifoaming agent precursor disposed in a liquid medium, and drying the treated stirrer.

10. The method of claim 1, wherein the antifoaming agent is a non-silicone antifoaming agent.

11. A method for making a beverage stirrer, comprising:
providing a beverage stirrer having an elongated body and comprising a porous substrate;
treating the substrate with a composition comprising a non-silicone antifoaming agent disposed in a liquid medium such that a portion of the composition is absorbed by the porous substrate; and
drying the treated substrate.

12. The method of claim 1, wherein drying the treated substrate forms a film of the antifoaming agent on the surface of the substrate.

13. The method of claim 12, wherein the non-silicone antifoaming agent is a fatty acid antifoaming agent.

14. A beverage stirrer, comprising:
an elongated body; and
a water-insoluble antifoaming agent disposed on said elongated body.

15. The beverage stirrer of claim 14, wherein the stirrer is porous.

16. The beverage stirrer of claim 14, wherein the stirrer comprises a cellulosic material.

17. The beverage stirrer of claim 14, wherein, wherein the stirrer is wooden.

18. The beverage stirrer of claim 14, wherein the stirrer comprises a fibrous material.

19. The beverage stirrer of claim 14, wherein the antifoaming agent is a non-silicone antifoaming agent.

20. The beverage stirrer of claim 14, wherein the antifoaming agent is crosslinked.
